(19) United States
(12) Patent Application Publication
(10) Pub. No.: US 2006/0021866 A1
(43) Pub. Date: Feb. 2, 2006

(54) Device for making distilled spirit

(76) Inventor: Wen-Wei Cheng, Yun-Lin County (TW)

Correspondence Address: CHARLES E. BAXLEY, ESQ., 90 JOHN STREET, THIRD FLOOR, NEW YORK, NY, 10038, US

(21) Appl. No.: 11/182,454

(22) Filed: Jul. 15, 2005

(30) Foreign Application Priority Data
Jul. 29, 2004 (TW) 093212064

(51) Int. Cl. B01D 3/42; C12G 1/00

(52) U.S. Cl. 202/160; 426/12

(57) ABSTRACT

A device for making distilled spirit includes a distiller body which has a storage container and a temperature sensor is connected to an outside of the distiller body and located corresponding to the storage container which includes a heater and a condenser connected thereto. The condenser is connected to an outside of the distiller body and has an automatic control switch. A lid is removably connected to the distiller body and a feeding device is connected to the lid. The lid has a control valve for controlling ratio of yeast and glycolytic enzymes. The temperature sensor, the automatic cooling switch, the control valve, the heater and the cooler are connected by the control panel.

### FIELD OF THE INVENTION

The present invention relates to a device for making distilled spirit, and more particularly, to a device that makes the distilled spirit within a single distiller body.

### BACKGROUND OF THE INVENTION

A conventional distiller device for the family is shown in FIG. 3, which requires a few more steps than just dumping the grains into the distiller. The grains (a round-shaped sticky white rice) are steamed until the center of the rice becomes transparent, wait for the rice to cool down, and then add qu into the rice. The yeast in the qu will breakdown the starches. The process needs three to four days to make the yeasts to become more potent. By adding water, not only acidity and sugar content are decreased, but also giving the yeasts more room to growth. It will take ten to fourteen days for the yeasts to breakdown starches into sugar, and then the yeasts will turn sugar into ethanol. Put the grains into the bottom of distiller then heat it up, the tip of distiller will collect the evaporated ethanol, which will become liquefied ethanol after cooling down. Conventional way is to ferment the grains in one container to become a qu, which is low in alcohol content in nature. It will require a distiller to upgrade the alcohol content.

There are two drawbacks from this cumbersome procedure: 1) While turning into qu from the grains, a few uncontrollable factors like temperatures and humidity will produce qu of inferior quality. The qu with poor quality will hinder the further purification, 2) When putting qu into the distiller, it's inevitable for qu to have a contact with air. The bacteria in the air will acidify distillation, which renders products with a poor quality. According to years of experience, the only way to solve this technical problem is to do the whole distillation in a single container.

### SUMMARY OF THE INVENTION

The present invention relates to a device for making distilled spirit and comprises a distiller body, a condenser, a feeding device, and a control panel. The distiller body has a storage container which includes a heater and a condenser connected thereto. A temperature sensor is connected to an outside of the distiller body and located corresponding to the storage container. The condenser is connected to an outside of the distiller body and has an automatic control switch. A lid is removably connected to the distiller body and the feeding device is connected to the lid. The lid has a control valve for controlling ratio of yeast and glycolytic enzymes. The temperature sensor, the automatic cooling switch, the control valve, the heater and the cooler are connected by the control panel.

The present invention is a distiller, which contains a storage area and a heating area. With a detachable condenser and an opened area, the device becomes an isolated entity. The heater will transform the qu with lower grade alcohol content to vaporized alcohol, and then the condenser will liquefy the vapor into distilled alcohol. My invention will transform the grains into distilled alcohol in one-step procedure. This invention will not allow qu to contact air; therefore, problems of acidification can be avoided. The device not only simplifies the distillation process, but also cut down the cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of the device of the present invention;

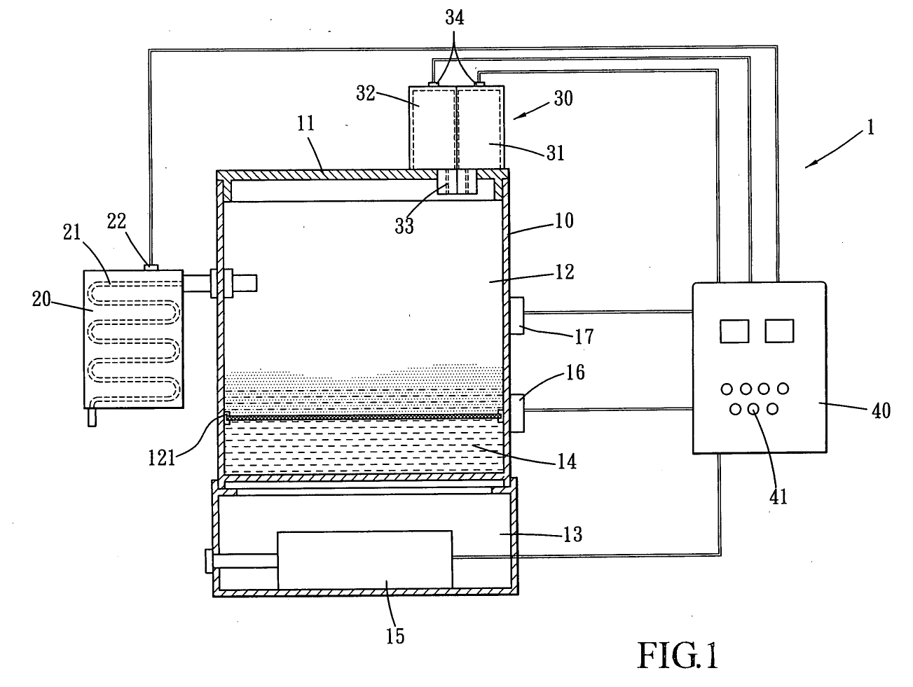

FIG. 2 shows the device for making distilled water, and

FIG. 3 shows a conventional device for making distilled spirit.

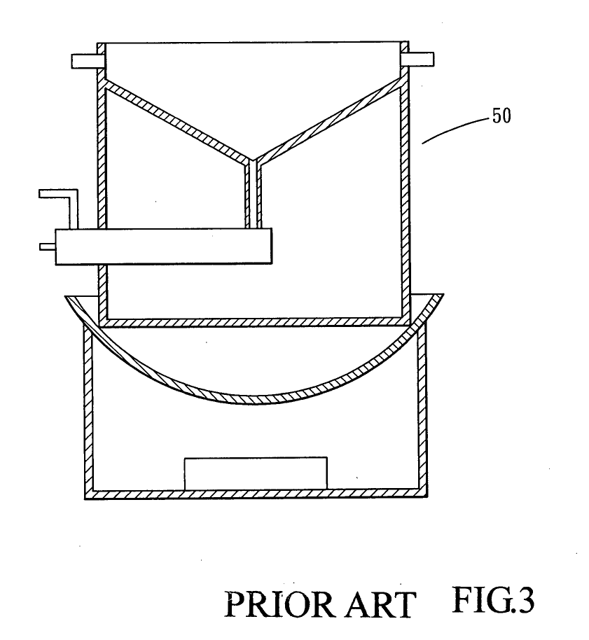

### DETAILED DESCRIPTION OF THE PREFERRED EMBODIMENT

The device of the present invention comprises a distiller 1 which contains a distiller body 10, a condenser 20, a feeding device 30, and a control panel 40. The distiller body 10 contains a lid 11, which seals the storage area 12. Within the storage there is a removable filter 121. Inside the storage area 12, there is a storage container 14, which can be used to mix grains, water, and yeast together to make thin stillage. Outside the storage, there are temperature sensor 16 and condenser 17. The temperature sensor detects the temperature within the storage area 12. When temperature drops to the right temperature, the sensor 16 will send a message to the control panel 40, and the heater 15 in the heating area 13 increases the temperature through the indirect command from control panel 40. On the other hand, when the temperature gets too high, the control panel 40 will start a cooler 17 to cool down the temperature. This invention provides a constant temperature within the storage area 12, which provides the best environment for the thin stillage.

For the convenience of pouring a large quantity of either the grains or fruits, the distiller body 10 has an opened area on the top. The lid 11 helps to close the area. The lid has a hole which can be sealed, so that, by engaging the feeding device (30), the lid 11 becomes a totally isolated area. In the mean times, the distiller body is completely isolated from the other part. There is a connection between the distiller body 10 and the condenser area 10, this connection will enable the vapor to get into condenser 20. The function of a condenser 20 is to liquefy the vaporized alcohol by a condenser tube 21 which is able to cool down the vapor rapidly. This condenser includes a removable condenser tube 21, which is different from the existing distiller and has an advantage for replacement of the condenser tube 21. The current system has either a separate part or welds itself as a one-piece structure. This feature is handy when trying to replace the condenser tube 21 within the condenser 20. By using the automatic control panel 22, the attached-condenser 20 is able to decide when to start or stop the transportation of the vaporized alcohol. This separate condenser 20 is able to send the vapor to condenser tube 21 to be liquefied. The separation of vaporization and liquidation can eliminate the water content; therefore, the procedure requires less time. (It will take more time to purify the liquor, when the water content is high.)

The feeding device 30 which is attached to the lid 11, is a separate area that contains two compartments. Compartment one 31 has a ready-mixed glycolytic enzyme (A mixture of liquefied yeast and glycolytic enzymes.) Compartment two 32 contains yeast. At the bottom of compartment one and two 31, 32, there is a delivery tube 33, which can be used to deliver materials into each compartment. A control valve 34 outside the distiller can control the quantity delivered into the delivery area, this feature keeps the quality control of distillation in an excellent condition.

The control panel 40, the temperature sensor 16, the automatic cooling switch 22, the control valve 34, the heater 15, and the cooler 17 are all connected to each other. By adjusting the system or the individual components via the control panel 40, the distillation procedures are more efficient and assures the quality control.

Rice is taken as an example to explain how to use this device. First, removing the lid 11 and pouring one part of rice and four parts of water from the storage area 12 into a storage container 14, and then close the lid 11. Second, connecting the condenser 20 through a side hole and the feeding device 30 seals the lid 11 with its own delivery tube 33. Therefore the distiller 10 is in a sealed status.

By using a hearer at the bottom of heating area 13, the grains are cooked and sterilized. The control panel 40 indirectly commands the control valve 34 to move glycolytic enzymes in the compartment one 31 into storage container 14 through delivery tube 33 at the ratio of 00.3. After breaking down the starches, then add the ratio of 00.1 of yeast thru automation. It will take ten to fourteen days to turn sugar into alcohol.

Through the control panel 40, the heater 15 warms up the temperature of alcohol to 78.3° C. at the storage area 12 to be vaporized alcohol. The control panel 40 then triggers the automatic control switch 22 of the condenser 20 to send the vaporized alcohol to the condenser 20, the cooling tube 21 then quickly liquefy the vaporized alcohol. Finally, we can collect the liquefied alcohol with a container through the exit of condenser 20.

There are few advantages of this design; a) one-step procedure, which provides no chance for alcohol to contact air; therefore, acidification will not be an issue, b) the automatic temperature sensor 16 is highly sensitive; this sensitivity will guarantee the quality of alcohol, and c) this device has merged mixing and distillation into one single procedure, this will cut the costs and speed up the time requires to make alcohol.

The control panel 40 has five functional control buttons 41. The operators can pick up any of the buttons that fit individual needs. This feature is very useful, especially for those who have never had any experience with making alcohol. The five functional control buttons are 20% alcohol button, 40% alcohol button, rice alcohol button, cooking rice alcohol button and distilled water button.

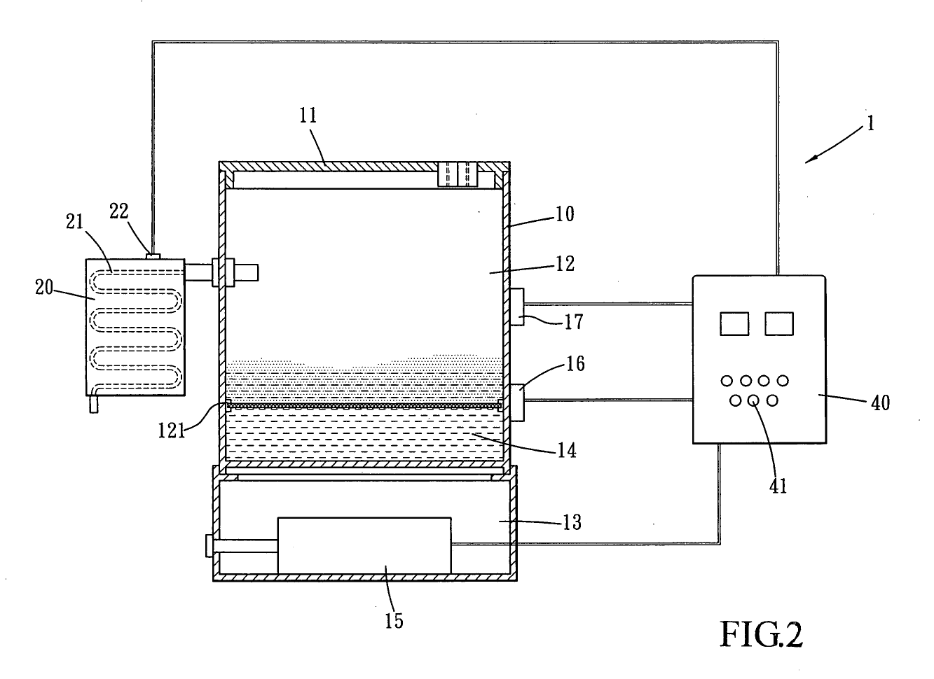

Of more important is that, distilled water can be made by this device. After removing feeding device 30, you can use a tapered stopper to hook up the lid 11. This will seal the distilled area (FIG. 2) and distilled water can be available after heating and condensation.,

While we have shown and described the embodiment in accordance with the present invention, it should be clear to those skilled in the art that further embodiments may be made without departing from the scope of the present invention.

What is claimed is:

1. A device for making distilled spirit, comprising:
a distiller body, a condenser, a feeding device, and a control panel, the distiller body having a storage container which includes a heater and a condenser connected thereto, a temperature sensor connected to an outside of the distiller body and located corresponding to the storage container, the condenser connected to an outside of the distiller body and having an automatic control switch, a lid removably connected to the distiller body and the feeding device is connected to the lid, the lid having a control valve for controlling ratio of yeast and glycolytic enzymes, the temperature sensor, the automatic cooling switch, the control valve, the heater and the cooler being connected by the control panel.

2. The device as claimed in claim 1, wherein the control panel includes five functional control buttons for making 20% alcohol spirit, 40% alcohol spirit, rice alcohol, cooking rice alcohol and distilled water.

3. The device as claimed in claim 1, wherein the feeding device includes compartment one and compartment two.
